(19) United States
(12) Patent Application Publication
(10) Pub. No.: US 2017/0016626 A1
(43) Pub. Date: Jan. 19, 2017

(54) COOKING APPLIANCE COMPRISING THERMOCHROMIC ELEMENTS FOR PROVIDING AN INDICATION ABOUT THE TEMPERATURE

(71) Applicant: Indesit Company S.p.A., Fabriano (IT)

(72) Inventors: Leonardo Arteconi, Fabriano (IT); Alberto Gasparini, Fabriano (IT)

(21) Appl. No.: 15/300,954

(22) PCT Filed: Apr. 1, 2015
(86) PCT No.: PCT/IB2015/052388

§ 371 Date: Sep. 30, 2016

(30) Foreign Application Priority Data
Apr. 3, 2014 (IT) TO2014A000277

(51) Int. Cl. F24C 15/04; G01K 11/12; F24C 7/08

(52) U.S. Cl. CPC F24C 15/04; F24C 7/085; G01K 11/12

(57) ABSTRACT

The door comprises at least one or more panels of thermal glass, on which thermochromic elements are applied, which are arranged close to one another, and which have respective activation temperature ranges, thus providing an easy-to-see indication of the temperatures in the oven.

### FIELD OF THE INVENTION

In a general aspect thereof, the present invention relates to a household cooking appliance equipped with thermochromic temperature indicators.

### BACKGROUND

The thermochromic materials taken into consideration herein are those known in the art, which change their colour according to the temperature they are exposed to.

They are usually made of coloured pigments that may be either organic (such as gadyl, spiropyrane, polyvinyl acetate resin) or inorganic (such as silver, mercury, titanium hydroxides and the like, often bound to cobalt and copper).

These pigments are used for making inks, thin films or even solid substrates, generally of the ceramic or fibrous kind.

The change in colour may be either reversible or irreversible, depending on the pigment in use, and thermochromic materials may also be semiconductors or liquid crystals.

In a more particular aspect, the household cooking appliances to which the present invention relates are ovens, whether of the type to be embedded into a kitchen or incorporated into a stand-alone household appliance, commonly called range, comprising an oven underneath a cooking top provided with burners, wherein the household appliance may be operated with gas or electrically.

In order to better understand the field of use of the invention, reference should be made to the state of the art, which includes British patent application No. 2312954, that discloses the use of thermochromic materials for detecting the cooking temperature of food.

In brief, this prior patent application teaches to apply thermochromic materials to a container for food to be cooked: in this way it is possible to verify the achievement of a preset food cooking temperature by simply relying on the chromatic change occurring in the material applied to the container in which the food has been placed (e.g. a dish, a bowl, a tray, etc.)

For example, if a temperature of 50° is to be maintained, it can be detected by using a thermochromic material applied to the container, which has a chromatic transition within a range that may indicatively be of 5° C. around 50° C.

The thermochromic material employed in the British patent application for this type of utilization may be either inorganic or organic, and may also be photochromic, i.e. sensitive to luminous radiation, according to which it will change its colour; the thermochromic material is formulated into a support composition for fluid, solid or semi-solid application, such as ink, paint, lacquer, paste, film or pack.

Alternatively, the support composition may comprise a thermoplastic or adhesive film to be applied to the substrate by heat or pressure.

The thermochromic material thus conceived must be applied in those regions of a microwave oven which are in contact with the food container: it is known, in fact, that one characteristic of microwave ovens is that they heat food by interacting with the water molecules contained therein, without heating the air or the walls of the cooking chamber that houses the container of the food to be heated.

It follows, therefore, that the teaching that can be derived from the above-mentioned British patent application is a system for detecting the temperature of an oven which is not very effective and which is de facto limited to food containers and nearby oven regions, the surface of which is in contact or in thermal exchange with such containers: this is the only way, in fact, in which the oven region close to the container can change its temperature.

It should also be pointed out that, also from a practical viewpoint, the solution described in the British publication is not very effective because it requires visual access to the inside of the oven in order to be able to detect the colour of the thermochromic elements associated with the food container: this is not always possible, since the container may have a shape that affects visibility; in addition, in microwave ovens the container is generally placed on a rotary tray, so that checking colour changes is a rather uncomfortable operation. If we also consider that the doors of microwave ovens are normally equipped, for safety reasons, with a metallic mesh screen, it can be understood that the visibility of a food container placed inside will be insufficient for this purpose.

### SUMMARY OF THE INVENTION

In this context, the technical object of the present invention is to provide a household appliance for food cooking which overcomes the above-mentioned drawbacks of the prior art.

The idea for achieving the object underlying the invention is to apply thermochromic elements to cooking appliances, such as ovens and the like, operating with gas or electrically (i.e. not with microwaves), such that a substantially uniform temperature distribution will be obtained in the cooking chamber, and the thermochromic elements will give a temperature indication corresponding to the actual cooking temperature of the food inside the oven.

Furthermore, according to a preferred embodiment of the invention, the thermochromic elements are applied to the oven door: this provides two effects: immediate visibility of the temperature indication, and preservation of the integrity of the thermochromic materials even with the high temperatures that can be reached by gas or electric ovens, especially pyrolitic ones.

### BRIEF DESCRIPTION OF THE DRAWINGS

The main features of the invention will be specifically set out in the claims appended to this description; such features, as well as the effects and advantages deriving therefrom, will become more apparent in the light of the following description of one preferred but non-limiting embodiment thereof, which is provided herein with reference to the annexed drawings, wherein:

FIG. 1 is a perspective view of an oven according to the invention;

FIGS. 2 and 3 show respective details of a door of the oven of FIG. 1;

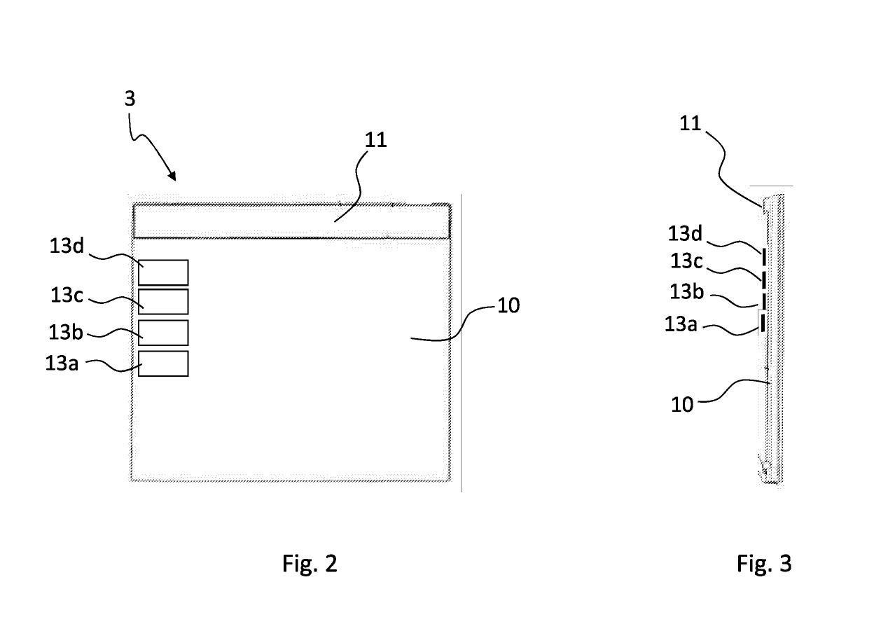

FIGS. 4 and 5 show a variant of the detail of FIGS. 2 and 3; and

FIG. 6 is a table that shows the temperature values inside and on the door glasses of an oven according to the invention.

### DETAILED DESCRIPTION OF THE EMBODIMENTS

With reference to the above-listed drawings, reference numeral 1 designates as a whole a household cooking appliance according to the invention, which consists of an oven to be embedded into kitchen furniture (not shown for clarity).

The oven 1 may be operated electrically or with gas, and comprises the usual muffle structure 2, within which there is a cooking chamber, closed at the front by a door 3, surrounded by a frame 4, which constitute the front panel of the oven visible from the outside.

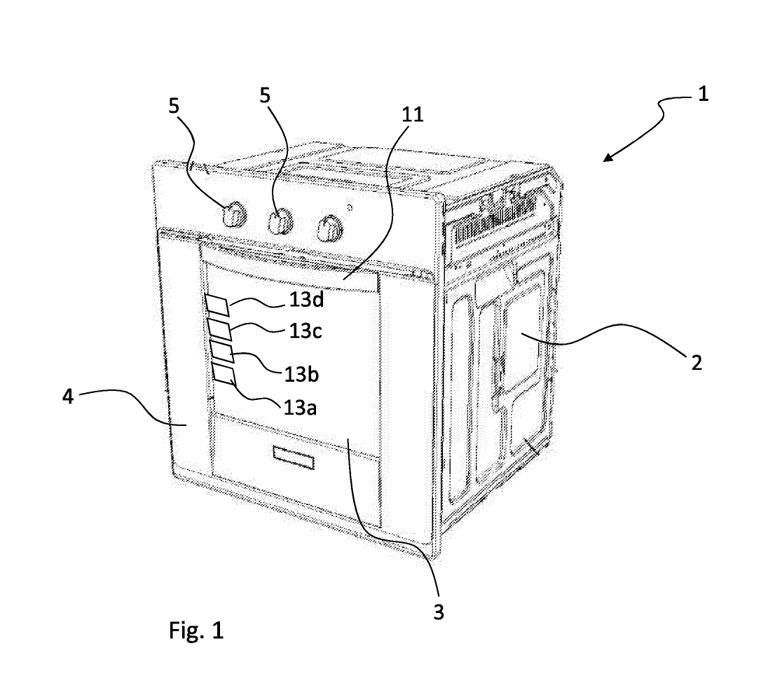

On said front panel the oven there are arranged control means, which in this case are simple knobs 5; of course, such control means may be different, e.g. push-buttons, levers, sliders, keypads or the like, and it is also clear that the front panel of the oven may include indicators, displays, warning lights and other devices for interfacing to and/or controlling the oven, not shown in FIG. 1 for simplicity.

In this regard, it is worth specifying that this description will only refer, for simplicity and clarity, to those elements of the oven 1 which are useful for understanding the invention; for further details about ovens, reference should be made to the prior art, for instance ovens manufactured or described in patent applications by the present Applicant; among the many available, European patent application EP 2239511 is recommended.

Likewise, it is also worth mentioning that the elements of the invention and the configuration or representation thereof as shown in the drawings, can be combined as deemed appropriate in one or more embodiments of the invention, the latter not being limited to the exemplary embodiments that will be taken into account herein.

The oven door 3 is, in this first example, a transparent panel 10, typically made of glass and having a substantially rectangular or anyway quadrilateral shape, at the top of which there is a handle 11; the door 3 is horizontally pivoted to the oven muffle 2a through hinges, thus allowing access to the cooking chamber within the muffle 2.

To the glass of the door panel 10 a series of thermochromic elements 13a, 13b, 13c, 13d are applied in the form of labels, tags or the like.

The thermochromic elements are sensitive to respective temperature ranges, e.g. intervals of 2-3° C. each, and are arranged close to one another, thus substantially forming a graduated temperature scale.

In particular, said respective temperature ranges of the various thermochromic elements are different and contiguous, so as to constitute a continuous graduated scale.

Preferably, each thermochromic element 13a-13d is characterized by a respective colour, which is activated when the temperature is within the respective temperature range, namely it is activated when the threshold temperature of the chromic transition range is reached, and deactivated when the off threshold is trespassed.

Of course, the number of thermochromic elements and their shape may be different from those shown in the drawings; for example, there may be thermochromic elements also showing numerical temperature values corresponding to their respective colour, wherein the latter may in such a case be similar for all indicators, since the temperature indication will be provided in numerical form by the respective indicator 13a-13d.

Also the geometry of the temperature scale formed by the thermochromic elements may be other than linear; for example, a circular geometry may be considered, wherein the thermochromic elements constitute respective sectors of a circle (or of a circumference), each one active within a respective temperature range.

More in general, it can be stated that the most important part of the present invention is not the shape of the thermochromic elements, but their application outside the oven or anyway in regions thereof which stay at temperatures that are sufficiently low to not jeopardize or damage the integrity of the thermochromic elements and of any means employed for securing them.

In accordance with this teaching, the thermochromic elements 13a-13d are applied to the outer side of the oven door 3, or, for doors comprising multiple panels, in the interspaces defined between the latter, as will be better explained below.

In this frame, it must be pointed out that the thermochromic elements should be chosen appropriately for providing an indication of the temperature in the cooking chamber of the oven 1: it is in fact apparent that, since the thermochromic indicators 13a-13d are applied to the glass panel 10 of the oven door, they will detect the temperature of the latter, which will be different from but dependent on the temperature inside the muffle 2.

As a consequence, the thermochromic elements should be chosen on the basis of design data, preferably experimental ones, which correlate the temperature of the panel 10 of the door 3 to the temperature inside the muffle 2.

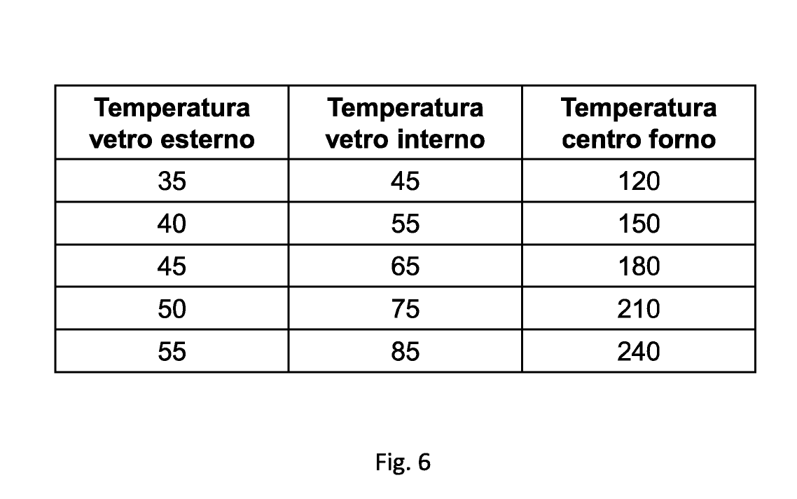

One example of this situation is shown in FIG. 6, which shows a table listing the temperatures inside the oven and on the glass panels of a double-glass door.

Temperature values are detected through thermocouple probes, as is usually done in the art; to this end, the temperature is detected on the inner glass and on the outer glass, whereto the thermochromic elements can be applied. In both cases, the thermochromic elements are preferably placed on the glass side facing the user for better readability.

From the above description one can understand how the above-described oven can perform the technical task at the basis of the invention.

In fact, the use of a plurality of thermochromic elements 13a-13d arranged close to one another, or anyway in such a way as to constitute a graduated temperature scale, allows an immediate evaluation of the thermal conditions inside the cooking chamber of the oven.

Since the thermochromic elements are located outside the oven, or anyway in peripheral regions thereof which stay at a relatively low temperature compared to the temperature in the cooking chamber of the oven, this embodiment of the invention is easily applicable to existing ovens, hence being a low-cost solution; the temperature indication obtained from the application of the thermochromic elements according to the invention is therefore reliable and effective.

Of course, the invention may be subject to many variations with respect to the example taken into consideration so far.

As already stated in regard to the configuration and arrangement of the thermochromic elements and their temperature and colour characteristics, they can be provided as simple labels or tags that, when a certain temperature is reached, highlight the value thereof by changing their colour.

Other alternatives are however also conceivable as concerns the application of the thermochromic elements.

In fact, although the arrangement outside the panel 10 of the door 3 is certainly preferable, in the cases of oven doors having two, three or even more glasses the thermochromic elements may be arranged in the interspace defined between two adjacent glass panels; in this respect, it is however always preferable to apply the elements to the outermost panel relative to the cooking chamber, i.e. farthest from the latter.

This ensures better visibility of the thermochromic element from the outside, and the element will be on the surface having the lowest temperature among those that delimit the interspace. The table of FIG. 6 refers to this circumstance.

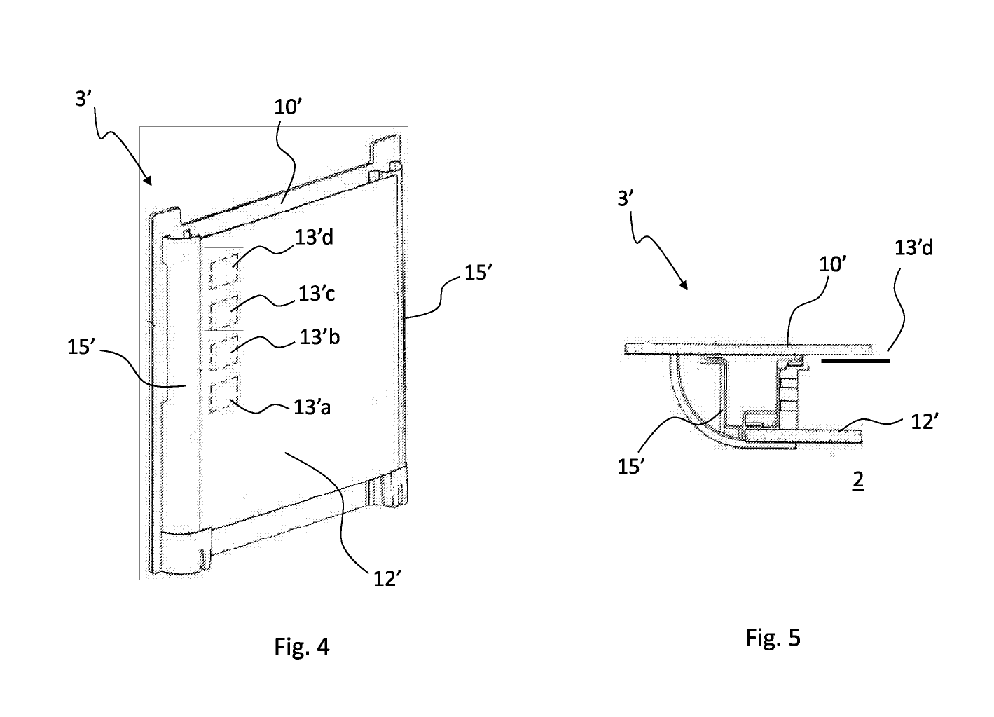

The situation just described is visible in FIGS. 4 and 5, which show the oven door referred to above, with a couple of opposite glass panels forming an interspace between them; for simplicity, in these drawings those elements which are structurally or functionally equivalent to those already described are designated by the same reference numerals, with the addition of an apostrophe.

As can be seen, the door 3′ comprises a first front panel 10′ opposite to a second panel 12′.

In accordance with this variant of the invention, the thermochromic elements 13′a-13′d are housed within an interspace 20′ defined between the two glass panels 10′, 12′; the results attained by this embodiment correspond to those already described above, in that the thermochromic elements are housed in an environment having a lower temperature than the muffle 2′, which temperature is however controlled; it should be remembered that safety regulations require that the oven door must remain, when in operation, at temperatures below predetermined values ranging from 70 to 80° C.

For this purpose, in the interspace 20′ there is a forced or natural convection ventilation system that allows removing the heat transmitted from the muffle 2, which in ovens may reach temperatures of the order of 150-200° C. and more. The interspace, instead, is preferably kept at temperatures between 70 and 90° C.

In this context, it must be pointed out that the number of glass panels may also be higher than two; this will have no influence on the basic principles of the invention.

This variant and any other variants will still fall within the scope of the appended claims.

1-11. (canceled)

12. An oven appliance comprising:
a muffle defining a food cooking chamber; and
a door operably coupled with the muffle and moveable between open and closed positions, the door comprising:
at least one substantially transparent panel having a plurality of thermochromic elements arranged in close proximity to one another and having respective activation temperature ranges, so as to provide an indication about the temperatures inside the muffle.

13. The oven appliance of claim 12, wherein the thermochromic elements are arranged on an external portion of the door.

14. The oven appliance of claim 12, wherein the thermochromic elements are arranged on an internal portion of the door.

15. The oven appliance of claim 12, wherein the door includes a pair of opposing panels that define an interspace in which the thermochromic elements are arranged.

16. The oven appliance of claim 15, wherein the thermochromic elements are applied to the outermost panel of the door.

17. The oven appliance of claim 12, wherein the thermochromic elements are arranged according to a substantially linear geometry.

18. The oven appliance of claim 12, wherein the thermochromic elements are arranged according to a substantially circular geometry.

19. The oven appliance of claim 15, wherein the thermochromic elements are adhered to a panel of the door.

20. The oven appliance of claim 19, wherein the thermochromic elements are self-adhesive.

21. The oven appliance of claim 12, wherein the thermochromic elements have alphanumerical indicia visible within predefined temperature ranges, so as to provide indications about the temperature in the muffle.

22. The oven appliance of claim 12, wherein the thermochromic elements are active within different and contiguous respective temperature ranges, thus forming a continuous graduated scale.

23. An oven appliance comprising:
a muffle including a plurality of walls defining a food cooking chamber;
a plurality of controls disposed on a face of the muffle for controlling internal temperatures of the muffle; and
a door operably coupled with the muffle and moveable between open and closed positions, the door comprising:
at least one substantially transparent panel configured to allow viewing of the food cooking chamber;
a plurality of thermochromic elements arranged on the door, each of the plurality of thermochromic elements having a different activation temperature range, so as to provide an indication about the temperatures inside the muffle.

24. The oven appliance of claim 23, wherein the thermochromic elements are arranged on the substantially transparent panel of the door.

25. The oven appliance of claim 23, wherein the thermochromic elements are sensitive to respective temperature ranges of 2°-3° C.

26. The oven appliance of claim 23, wherein the door includes a pair of opposing panels that define an interspace in which the thermochromic elements are arranged.

27. The oven appliance of claim 26, wherein the thermochromic elements are applied to the outermost panel of the door.

28. The oven appliance of claim 23, wherein the thermochromic elements are arranged according to a substantially linear geometry.

29. The oven appliance of claim 23, wherein the thermochromic elements are arranged according to a substantially circular geometry.

30. The oven appliance of claim 26, wherein the thermochromic elements are adhered to a panel of the door.

31. The oven appliance of claim 23, wherein the thermochromic elements have alphanumerical indicia visible within predefined temperature ranges, so as to provide indications about the temperature in the muffle.
